(19) United States
(12) Patent Application Publication
(10) Pub. No.: US 2012/0323649 A1
(43) Pub. Date: Dec. 20, 2012

(54) SYSTEM AND METHOD FOR DISPLAYING AN ADVERTISING ITEM LINKED WITH THE ACT OF PRINTING

(75) Inventor: Guy Rosenhoiz, Tel Aviv (IL)

(73) Assignee: PRINT IT GREEN, LTD., Tel Aviv (IL)

(21) Appl. No.: 13/523,092

(22) Filed: Jun. 14, 2012

Related U.S. Application Data
(60) Provisional application No. 61/496,862, filed on Jun. 14, 2011.

(51) Int. Cl. G06Q 30/02

(52) U.S. Cl. 705/14.4

(57) ABSTRACT

A method for providing an advertising item to a client device. The method comprises receiving a printing notification from the client device; selecting an advertising item from at least a database containing a plurality of advertisement items; generating a display window containing the selected advertising item; and sending the generated display window to the client device for display by the client device.

### CROSS REFERENCE TO RELATED APPLICATIONS

This application claims the benefit of U.S. provisional patent application No. 61/496,862 filed on Jun. 14, 2011, the contents of which are herein incorporated by reference.

### TECHNICAL FIELD

The invention generally relates to advertising over the internet, and more specifically to presentation of an advertisement responsive to a printing request.

### BACKGROUND

The ubiquity of access availability to information using the Internet and the worldwide web (WWW) has naturally drawn the focus of advertisers. The advertisers therefore pay different websites, such as Google® or AOL®, for the placement of their advertisements among these web pages.

The well-known advertising banner in web pages is generally undesirable to a viewer of a web page as it takes up display space from the web page in which the viewer would rather view useful content. That is, the banners typically reduce the amount of information displayed on a web page present on a client's display. In many cases, the viewer disables the banners or otherwise disables the ability of the browser to display advertisements. For example, all browsers can be configured to block pop-up windows or to render a web page on a user's display without advertisement banners. In addition, a typical web page itself is today cluttered with many advertisements and as a result the user's attention is not given to them.

It would be therefore advantageous to provide an advertisement space which overcomes the deficiencies of the prior art. It would be further advantageous if such advertisement space would avoid the current typical advertisement clutter.

### SUMMARY

Certain embodiments disclosed herein include a method for providing an advertising item to a client device. The method comprises receiving a printing notification from the client device; selecting an advertising item from at least a database containing a plurality of advertisement items; generating a display window containing the selected advertising item; and sending the generated display window to the client device for display by the client device.

Certain embodiments disclosed herein also include a system for providing an advertising item to a client device. The system comprises a processing unit; a memory coupled to the processing unit and containing at least instructions executed by the processing unit; a network interface coupled to the processing unit; and a source for providing at least an advertising item responsive of a notification of a printing request received from the client device, the client device being communicatively connected to the system via the network interface.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIGS. 1 and 2 are schematic diagrams of a networked system used to describe various embodiments disclosed herein.

FIG. 3 is a flowchart describing a method for displaying an advertising item responsive to a printing request according to one embodiment.

FIG. 4 is a screenshot of the display of a web based advertisement according to one embodiment.

FIG. 5 is a screenshot of the display of an advertisement embedded in a document according to another embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

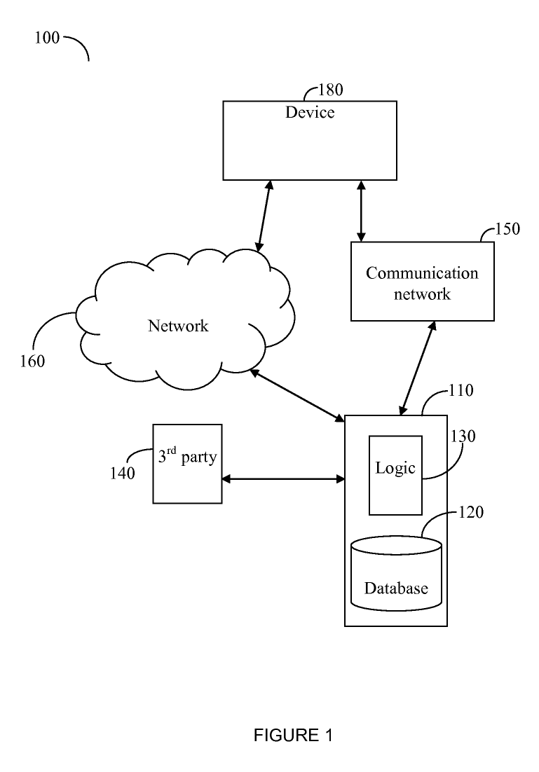

FIG. 1 depicts an exemplary and non-limiting networked system 100 utilized to describe the embodiments for displaying advertising items responsive to a printing request. A management server 110 stores one or more advertising items in a database 120. In one embodiment, a plurality of databases each storing one or more advertising items may be used as the database 120. The database 120 is configured to store and deliver advertising items. The management server 110 further comprises a logic 130 that contains a plurality of instructions embedded in a tangible memory of the management server 110. Such instruction when executed, for example, by a processor (not shown) of the management server 110 performs the function of displaying an advertising item generated and retrieved from the database 120 as further explained herein below in more detail. In one embodiment, advertising items can also be received from one or more third party providers 140. For example, the third party providers 140 are publish server of publishers of advertized content. The publisher severs are configured to embed online advertisements in web pages downloaded from web server servers, and further to upload web pages with advertisements to web browsers of client devices. The publisher servers typically receive the advertized content from advertising agencies that set the advertising campaign.

The management server 110 communicates with a device 180 via a communication network 150 or the Internet 160. The device 180 is configured to receive an advertising item from the management server 110. The device 180 may be, but is not limited to, a client agent utility, a client device, a server, a database, a web server hosting a website or a webpage, a data network, and any combination thereof. It should be noted that although one device 180 is depicted in FIG. 1 merely for the sake of simplicity, the embodiments disclosed herein can be applied to a plurality devices 180.

According to an embodiment disclosed herein, upon receiving a printing request from the device 180, the management server 110 selects an advertising item and sends it to the device 180 for display. It should be further understood that a single an advertising item may be comprised from a plurality of advertising items. The advertising item may be, for example, a keyword, an image, a video clip, a text description, another web page, search results retrieved from a search engine, and any combination thereof.

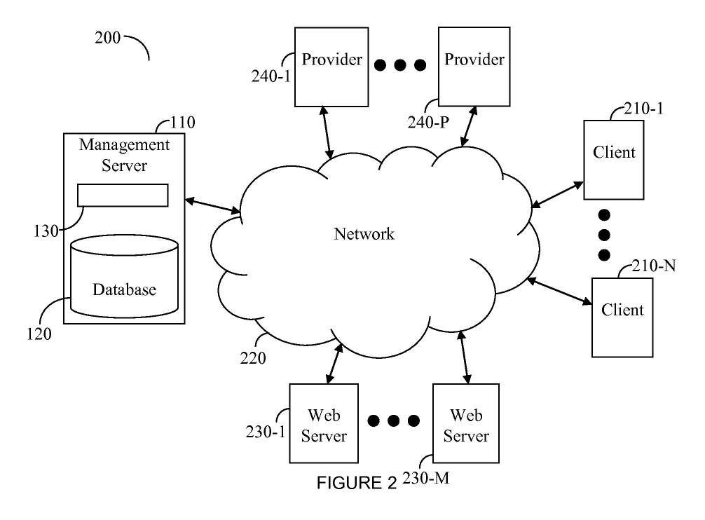

The operation of the management server 110 is further described with reference to FIG. 2 that depicts an exemplary and non-limiting networked system 200. A plurality of client devices 210-1 through 210-N are connected to a network 220. The network 220 includes, but not by way of limitation, a local area network (LAN), a wide area network (WAN), a metro area network (MAN), the Internet, the worldwide web (WWW), wired or wireless, and other types of communication networks, such as the communication network 150 (shown in FIG. 1), as well as any combination thereof. The client devices 210-1 to 210-N may be a personal computer (PC), a laptop computer, a mobile device, a smart phone, a tablet computer, and the like. In an embodiment, each client device 210-i (i=1, . . . , N) includes a monitoring agent (not shown) that is designed to capture print commands on the client device 210-i and to send a notification of the printing request a document to the management server 110. The monitoring agent can also send together with the print request information including, but not limited to, an IP address of the client device 210-i, a URL of a web page that the user requested to print, the type of the application from which the print command was issued, and so on. In one embodiment, the monitoring agent can be realized as an add-on of a software application installed in the client device 210, a toolbar of a web browser, a browser extension, and so on.

A plurality of web servers 230-1 through 230-M are also connected to the network 220. The plurality of web servers 230-1 through 230-M may be implemented as the device 180 shown in FIG. 1. As noted above, the management server 110 includes the database 120 that stores the advertising items, indexes thereto, and/or advertisement parameters. In one embodiment of the invention the database 120 is connected to a tracking server (not shown) configured to store information respective of the advertising items sent to each of client devices 210-1 through 210-N.

A plurality of third party providers 240-1 through 240-P are also connected to the network 220. Each of the third party providers 240-1 to 240-P can generate advertising items.

A management server, also referred to herein as the server 110, is also connected to the network 220 and is further equipped with a logic 130 comprised of a plurality of instructions embedded in the tangible memory of the server, that when executed by the server perform the function of displaying an advertising item as further explained herein below in more detail.

According to various embodiments disclosed herein, the management server 110 causes the display of an advertising item on the display of a client's device 210-i (i=1, . . . , N) responsive of a print request from a user of the client device 210-i. In an embodiment, when the client device 210-i attempts to print from any application executed thereon, such an attempt is captured by the monitoring agent and a notification is sent to the management server 110. In response, management server 110 generates and delivers an advertising item that is displayed on the display of the client device 210-i.

The displayed advertising item may be retrieved from the database 120 and/or a third party provider 240. In one embodiment, the management server 110 generates a window display which may be, for example, a web page or a display banner in a format of a pop-up window. The window display includes the advertising item. In another embodiment, the management server 110 sends a request to one of the third party providers 240 to generate an advertising item for display by the client device 210-i. As noted above, a third party provider may be a publisher server that generates a web page containing the advertising items and sends the generated web page to the client device 210-I or to the management server 110. In an embodiment, the advertising item in any display form is sent to the client device 210 through the monitoring agent. Thus, the management server 110 allows the display of an advertising item uncluttered by any other content and/or advertisements, thereby capturing the user's attention.

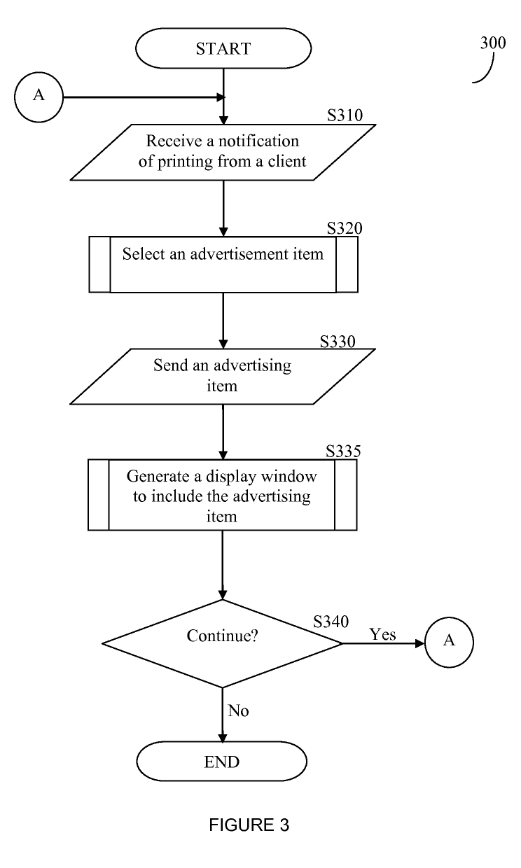

FIG. 3 depicts an exemplary and non-limiting flowchart 300 describing a method for displaying a web based advertising item linked with the act of printing according to an embodiment. In a non-limiting embodiment, the method is performed by the management server 110.

In S310, a server, for example the management server 110, receives a printing notification from a client device, for example, the client device 210-1. As mentioned above, the printing notification can be sent from a monitoring agent installed in the client device. In S320, an advertising item is selected by the management server 110 from, for example, the advertising items that are stored in the database 120. Alternatively or collectively, the advertising item is retrieved from a server 240 (e.g., a publisher server) upon a request from the management server. A selection of an advertising item may be performed in multiple ways including, but not limited to, random selection of an advertising items from a plurality of advertising items; a tailored advertising item selection that fits, for example, a profile of a user of the client device; selection of advertising items based on the printed content, and so on. In S335, a display window including the selected advertising item is generated. The display window may be, for example, a pop-up window, in a form of a web page or a display banner that can be displayed in software applications other than a web browser. In S330, the generated display window with the selected advertising item is sent to the client device. In S340, it is checked whether to continue with the execution, and if so, execution continues with S310; otherwise execution terminates.

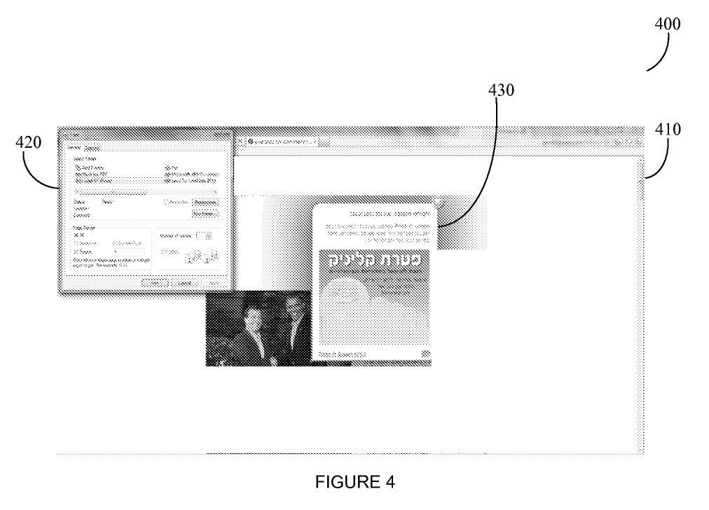

FIG. 4 depicts an exemplary and non-limiting screenshot 400 of the display of a web based advertising item according to an embodiment. A webpage 410 is displayed within a client's web browser on a client device. Upon receiving a printing request from the client's device, a pop-up window 420 appears where the user can select the type of printer to commence the act of printing. In parallel, a display window which is a pop-up window 430 appears containing an advertising item. According to the embodiments disclosed herein, the pop-up window 430 appears responsive to the printing notification that is sent to the management server 110. The management server 110 selects the advertising item to be displayed and generates the pop-up window, which in this non-limiting example is in a form of a web-page. As noted above, the advertising item in the pop-up window 430 may retrieve from the database 120 and/or a third party provider 240. It should be appreciated by a person skilled in the art that the location of the window 430 is just an example, as the advertising item can be positioned anywhere on the web page 410. In another embodiment, the advertising item is embedded in the web page 410.

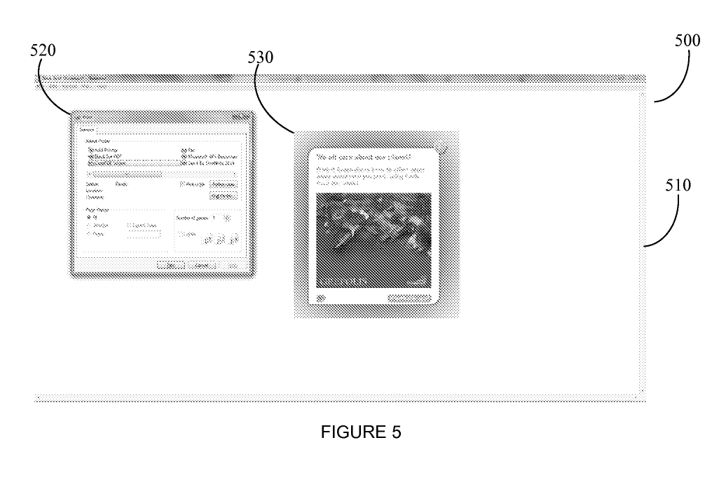

FIG. 5 depicts an exemplary and non-limiting screenshot 500 of the display of an advertising item on a client device according to another embodiment. A document 510, for example and without limitation, a Microsoft® Word document or Adobe® Acrobat®, is displayed over a client device, such as a client device 210. Upon receiving a notification about a request for printing by the client device 210, a pop-up window 520 appears in which the client can select the type of printer to commence the act of printing. In parallel, a display window 530 appears containing an advertising item according to an embodiment of the invention. The display window 530 appears responsive to the printing notification sent to the management server 110, as explained in more detail hereinabove. In the non-limiting example shown in FIG. 5, the display window 530 is in a form of a display banner. It should be further understood that the invention is not limited to applications handling documents but may also apply to other applications that may have printing capabilities.

The various embodiments disclosed herein can be implemented in as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers may be combined into one or more integrated servers. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing an advertising item to a client device, comprising:
receiving a printing notification from the client device;
selecting an advertising item from at least a database containing a plurality of advertisement items;
generating a display window containing the selected advertising item; and
sending the generated display window to the client device for display by the client device.

2. The method of claim 1, wherein the selected advertising item is at least one of: a keyword, an image, a video clip, a text description, another web page, and search results retrieved from a search engine.

3. The method of claim 1, wherein the selected advertising item appears on a pop-up window.

4. The method of claim 1, further comprises:
storing in the database information respective of the selected advertising item.

5. The method of claim 1, further comprises:
receiving the advertising item from at least one provider of advertising content.

6. The method of claim 1, wherein the display window is embedded in a document displayed on the client device.

7. The method of claim 1, wherein the display window is in a web page.

8. A non-transitory computer readable medium having stored thereon instructions for causing one or more processing units to execute the method according to claim 1.

9. A system for providing an advertising item to a client device, comprising:
a processing unit;
a memory coupled to the processing unit and containing at least instructions executed by the processing unit;
a network interface coupled to the processing unit; and
a source for providing at least an advertising item responsive of a notification of a printing request received from the client device, the client device being communicatively connected to the system via the network interface.

10. The system of claim 9, wherein the processor is further configured to:
generate a display window to include the selected advertising item; and
send the display window to the client device via the network interface.

11. The system of claim 9, wherein the selected advertising item is at least one of: a keyword, an image, a video clip, a text description, another web page, and search results retrieved from a search engine.

12. The system of claim 9, wherein the display window is a pop-up window.

13. The system of claim 9, further comprises: at least one database connected to the tracking server for storing information respective of the selected advertising item.

14. The system of claim 9, wherein the network interface further allows communication with at least one provider of advertising content through a network for receiving the selected advertising item from the least one provider.

15. The system of claim 9, wherein the display window is embedded in a document displayed on a client device.

16. The system of claim 9, wherein the display window is embedded in a web page.
